(19) United States
(12) Patent Application Publication
(10) Pub. No.: US 2014/0174487 A1
(43) Pub. Date: Jun. 26, 2014

(54) SHOWERHEAD CLEANING AND DISINFECTING SYSTEM AND METHOD

(71) Applicants: Thomas LaPorta, Fort Lauderdale, FL (US); Susan Jacoby, Fort Lauderdale, FL (US)

(72) Inventors: Thomas LaPorta, Fort Lauderdale, FL (US); Susan Jacoby, Fort Lauderdale, FL (US)

(21) Appl. No.: 14/132,540

(22) Filed: Dec. 18, 2013

Related U.S. Application Data
(63) Continuation of application No. 12/928,328, filed on Dec. 9, 2010, now abandoned.

(51) Int. Cl. B08B 9/027

(52) U.S. Cl. CPC B08B 9/027
USPC 134/166 C

(57) ABSTRACT

A showerhead cleaning and disinfecting system including an injection device located between a showerhead extension pipe and a showerhead. The injection device includes a port configured to receive an agent for cleaning and disinfecting the showerhead.

### RELATED APPLICATIONS

This application claims benefit of and priority to U.S. Provisional Application Ser. No. 61/284,023, filed on Dec. 11, 2009, and U.S. Provisional Application Ser. No. 61/398,255, filed on Jun. 23, 2010 under 35 U.S.C. §§119, 120, 363, 365, and 37 C.F.R. §1.55 and §1.78, incorporated herein by this reference.

### FIELD OF THE INVENTION

This invention relates to system and method for cleaning and disinfecting a showerhead without having to remove the showerhead from the supply pipe.

### BACKGROUND OF THE INVENTION

Showerheads typically build up calcium, lime, and other heavy materials after extended use. Such a buildup may significantly reduce the flow of spay from the showerhead.

Research suggests that showerheads may harbor potentially infectious disease causing bacteria and mold. One study suggests a typical home showerhead may have a concentration of harmful bacteria that is 100 times greater than water supplied to it. The problem may be further compounded because a reduced flow rate in a clogged showerhead may cause the bacteria and mold to build up inside the showerhead. When water flows through the tiny holes in the showerhead, it aspirates the water into the air as a mist. Any bacteria or mold festering in the showerhead may become airborne and may be breathed in by the person taking a shower. This may cause, inter alia, respiratory problems, disease, and allergic reactions for certain individuals.

One conventional approach to clean a showerhead is to remove it from supply pipe and soak it in a cleaning solution. Such a process is time consuming, cumbersome, and may often result in problems when re-installing the showerhead.

Another conventional approach for cleaning a showerhead without removing the showerhead from the supply pipe is disclosed in U.S. Pat. No. 5,970,995. As disclosed therein, the showerhead includes a collar with a hook for attaching a container with a cleaning solution to submerge the showerhead therein. Although the approach will clean the outside of the showerhead, the cleaning solution cannot enter the inside of the showerhead due to pressure gradient between air inside the showerhead and the cleaning solution. Thus, the method may be ineffective.

Yet another device for cleaning a showerhead is disclosed in U.S. Pat. No. 7,111,798. As disclosed in this patent, the showerhead may be cleaned by using nozzles with an external flexible nozzle layer which can be manipulated by a user. One drawback to this approach may be residual water droplets left inside the showerhead after use. This may produce bacteria, mold, and the like, which may require the showerhead to be cleaned with a disinfecting solution.

Other attempts to clean showerheads may rely on using ultraviolet radiation in conjunction with a showerhead (U.S. Patent Application Publication No. 2008/0169249) or cavitation mechanisms designed to kill bacteria present in residual water within the showerhead (U.S. Patent Application Publication No. 2010/0019067).

However, the conventional methods discussed above are typically ineffective, cumbersome, expensive, often difficult to install and operate, and often ineffective.

### BRIEF SUMMARY OF THE INVENTION

This invention features a showerhead cleaning and disinfecting system including an injection device located between a showerhead extension pipe and a showerhead. The injection device includes a port configured to receive an agent for cleaning and disinfecting the showerhead.

In one embodiment, a cover may be removably attached to the showerhead configured to contain the agent in the showerhead a predetermined amount of time to clean and disinfect the showerhead. The port may include a removable cap. The port may include a ball valve assembly. The adaptor may include a first end configured to connect to the showerhead extension pipe and a second end configured to connect to the showerhead. The agent may include a solution configured to clean and disinfect the showerhead. The agent may include a pressurized gas configured to clean and disinfect the showerhead. The pressurized gas may be coupled to the port and flows through the showerhead a predetermined amount of time in order to clean and disinfect the showerhead.

This invention also features a showerhead cleaning and disinfecting system including an injection device located between a showerhead extension pipe and a showerhead. The injection device includes a port configured to receive a solution for cleaning and disinfecting the showerhead. A cover is removably attached to the showerhead configured to contain the solution in the showerhead a predetermined amount of time to clean and disinfect the showerhead.

This invention also features a showerhead cleaning and disinfecting system including a showerhead integrated with a port configured to receive an agent for cleaning and disinfecting the shower head.

In one embodiment, a cover may be removably attached to the showerhead configured to contain the agent in the showerhead a predetermined amount of time to clean and disinfect the showerhead. The port may include a removable cap. The port may include a ball valve assembly. The agent may include a solution configured to clean and disinfect the showerhead. The agent may include a pressurized gas configured to clean and disinfect the showerhead. The pressurized gas may be coupled to the port and flows through the showerhead a predetermined amount of time to clean and disinfect the showerhead.

This invention further features a showerhead cleaning and disinfecting system including an extension pipe including a port configured to receive an agent for cleaning and disinfecting the showerhead.

In one embodiment, the system may include a cover removably attached to the showerhead configured to contain the agent in the showerhead a predetermined amount of time to clean and disinfect the showerhead. The port may include a removable cap. The port may include a ball valve assembly. The extension pipe may include a first end configured to connect a coupling behind a wall and a second end configured to connect to the showerhead. The cleaning agent may include a solution configured to clean and disinfect the showerhead. The cleaning agent may include a pressurized gas configured to clean and disinfect the showerhead. The pressurized gas may be coupled to the port and flows through the showerhead a predetermined amount of time in order to clean and disinfect the showerhead.

This invention further features a showerhead cleaning and disinfecting system for a multi-head shower environment including a multi-showerhead environment including at least a plurality of showerheads. A shut off valve is located between a water supply line and the multi-showerhead environment. An injection device is located between the shut off valve and the multi-showerhead environment. The injection device includes a port configured to receive an agent for cleaning and disinfecting the showerhead when the shutoff valve is closed.

In one embodiment, the agent may include a solution configured to clean and disinfect the showerhead. The system may include a plurality of covers each removably attached to the plurality of showerheads and configured to contain the solution in the showerheads a predetermined amount of time to clean and disinfect the showerheads. The system may include a container for storing the solution. The system may include a pump configured to inject the solution into the port and fill the plurality of showerheads with the solution. The agent may include a pressurized gas configured to clean and disinfect the showerheads. The pressurized gas may be coupled to the port and flows through the showerheads a predetermined amount of time to clean and disinfect the showerhead. The multi-showerhead environment may include a plurality of back-spray showerheads. The multi-showerhead environment may include an atmosphere spa.

This invention features a method for cleaning and disinfecting a showerhead including providing a port configured to receive an solution for cleaning and disinfecting the showerhead, removably attaching a cover to the showerhead, injecting the solution into the port to fill the showerhead with a predetermined amount of solution, and containing the solution in the showerhead for a predetermined amount of time to clean and disinfect the showerhead.

This invention further features a method for cleaning and disinfecting a showerhead including providing a port configured to receive a pressurized gas for cleaning and disinfecting the showerhead, and introducing the pressurized gas into the port and through the showerhead for a predetermined amount of time to clean and disinfect the showerhead.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1 is a three-dimensional front-view showing the primary components of one embodiment of the showerhead cleaning system of this invention;

FIG. 2A is three-dimensional front-view showing in further detail the structure of one embodiment of the injection device shown in FIG. 1;

FIG. 2B is a schematic side-view of the injection device shown in FIG. 2A;

FIG. 2C is a schematic top-view of the injection device shown in FIG. 2A;

FIG. 2D is a schematic end-view of the injection device shown in FIG. 2A;

FIG. 3A is a schematic side-view showing in further detail the structure of the cap attached to the injection port shown in FIG. 1;

FIG. 3B is a schematic front-view of the end cap shown in FIG. 3A

FIG. 4A is a three-dimensional-view of one example of a cover of one embodiment of the shower cleaning system of this invention;

FIG. 4B is a schematic front-view of another example of a cover of one embodiment of the shower cleaning system of this invention;

FIG. 4C is a schematic side-view showing in further detail the covers shown in FIGS. 4A-4B;

FIG. 5A is a three-dimensional-view showing one example of a dispensing device introducing a cleaning solution into the port of the injection device in accordance with one embodiment of this invention;

FIG. 5B is a three-dimensional-view showing one example of a pressurized gas used to clean and disinfect the showerhead in accordance with another embodiment of this invention;

FIG. 6A is a schematic top-view of another embodiment of the port shown in FIG. 1;

FIG. 6B is a schematic side-view of the port shown in FIG. 6A;

FIG. 7 depicts one example of the steps used to install on the showerhead cleaning system of one embodiment of this invention;

FIG. 8 is a schematic view of another embodiment of the showerhead cleaning system of this invention;

FIG. 9 is a three-dimensional view of another embodiment of the showerhead cleaning system of this invention.

FIG. 10 is a three-dimensional view showing in further detail the structure of the showerhead extension pipe shown in FIG. 9;

FIG. 11 is a schematic view of another embodiment of the showerhead extension pipe shown in FIG. 9;

FIG. 12 is a three-dimensional view of another embodiment of the showerhead cleaning system of this invention used to clean and disinfect a multi-showerhead environment; and

FIG. 13 is a schematic front-view showing in further detail the primary components of one embodiment of the system shown in FIG. 12.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

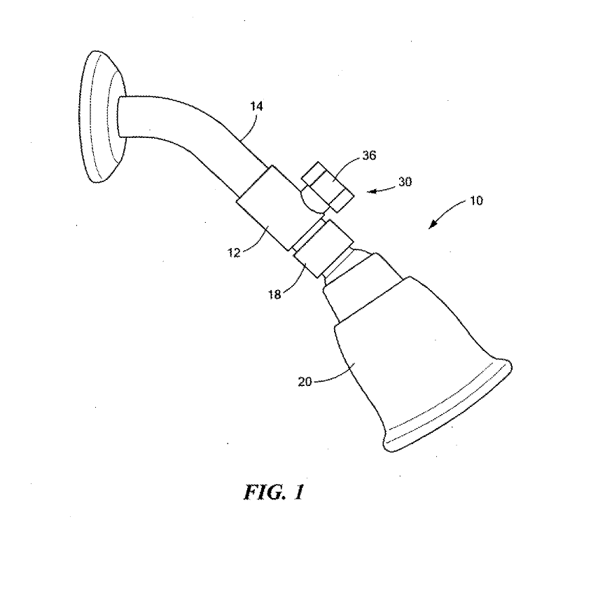

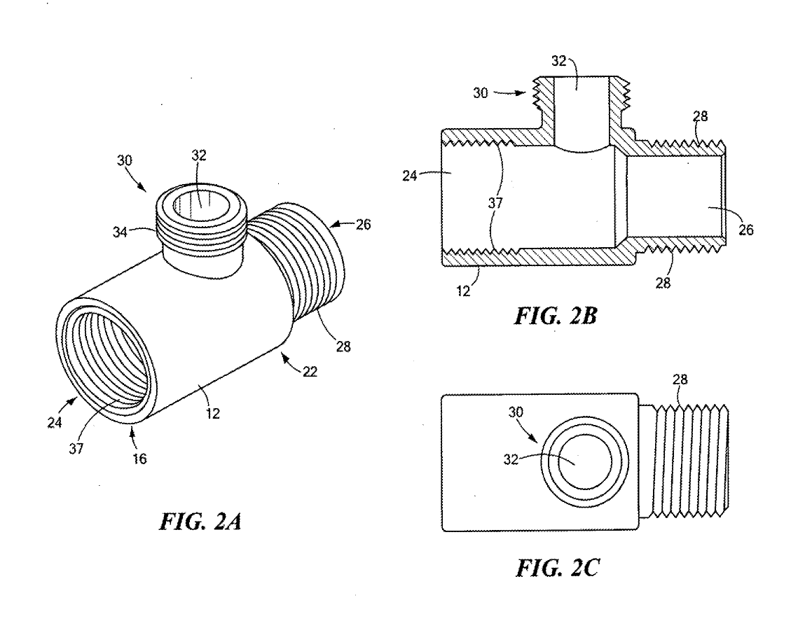

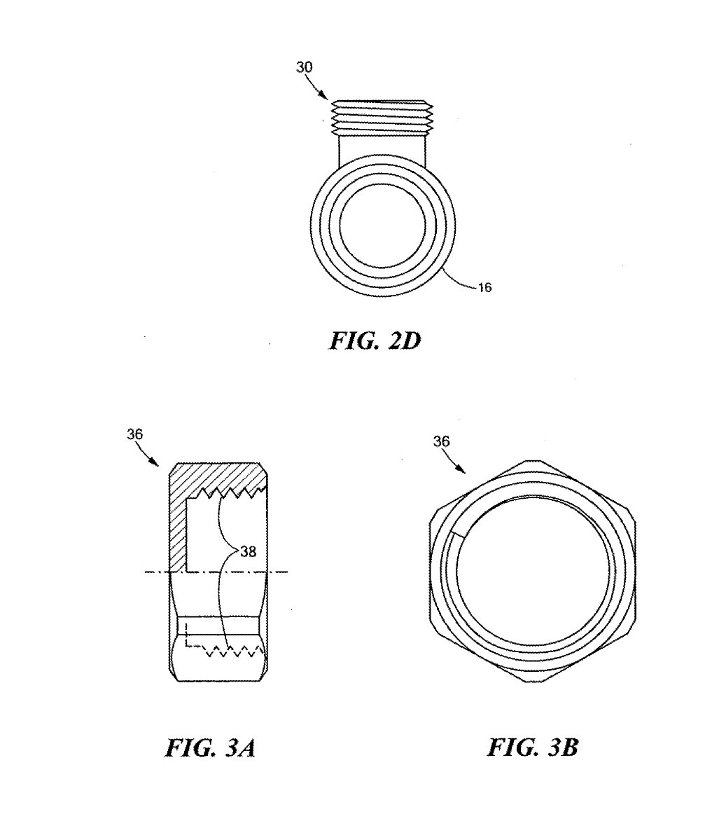

There is shown in FIG. 1 one embodiment of showerhead cleaning system 10 of this invention. In this example, system 10 includes injection device 12 which is preferably located between showerhead extension pipe 14 and showerhead 20. Injection device 12 includes port 30, shown in greater detail in FIGS. 2A-3B (discussed in further detail below), which is configured to receive an agent for cleaning and disinfecting showerhead 20.

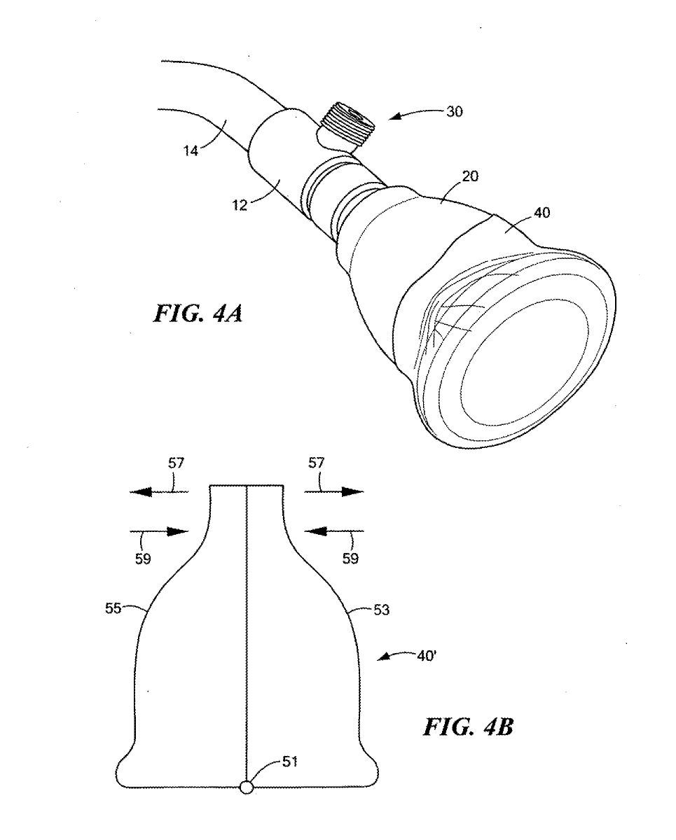

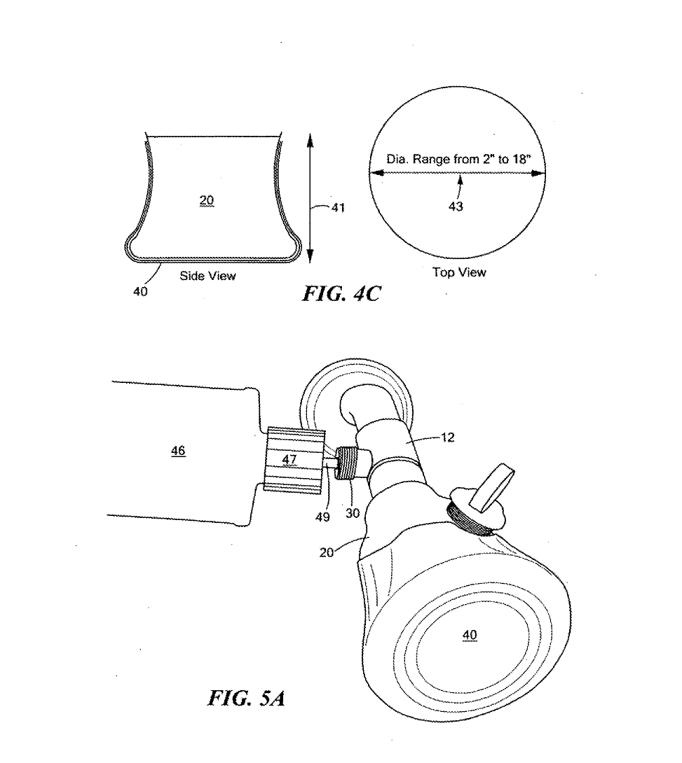

In one embodiment, system 10 also preferably includes cover 40, FIGS. 4A-4C, which is removably attached to showerhead 12. In one example, cover 40, FIG. 4A, may be made of a pliable material, such as rubber or similar type material. In this example, cover 40 preferably stretches over showerhead 20 and remains in place to hold the cleaning and disinfecting agent in showerhead 20 for a predetermined amount of time (discussed below) needed to clean and disinfect showerhead 20. In another example, cover 40′, FIG. 4B, may be manufactured to a shape which fits over showerhead 20. In this example, cover 40′ has a “clam shell” type design and is opened by pivoting on hinge 51 in the direction indicated by arrows 53. Cover 40′ is then clamped over showerhead 20 by moving members 53 and 55 in the direction indicated by arrows 57. Cover 40′, FIGS. 4A-4B, may have a height which ranges from about1¾ inches to about 5 inches, indicated at 41, FIG. 4C, and may accommodate a showerhead diameter ranging from about 2 inches to about 18 inches, indicated at 43. Cover 40, 40′ may also be designed to accommodate smaller or larger showerheads of different various shapes.

In one design, port 30, FIG. 1, includes removable cap 36, shown in greater detail in FIGS. 3A-3B. In one example, cap 36, FIG. 1, is removed, as shown in FIG. 4A, and the agent for cleaning and disinfecting showerhead 20 is injected into port 30. In one example, the agent for cleaning and disinfecting showerhead 20 may be a solution known to those skilled in the art which removes calcium, and/or lime, and/or heavy materials, and/or biofilm, and the like, and kills a majority of the bacteria, mold, and the like. In other examples, the agent for cleaning and disinfecting showerhead 20 may be a pressurized gas known to those skilled in the art which removes calcium, and/or lime, and/or heavy materials, and/or biofilm, and the like, and kills a majority of the bacteria, mold, and the like. The pressurized gas may be vaporized water (steam), a mixture of vaporized water and vaporized cleaning and disinfecting solution, or mixture any other gas or vaporized cleaning and disinfecting solution known to those skilled in the art which cleans and disinfects the showerhead 20.

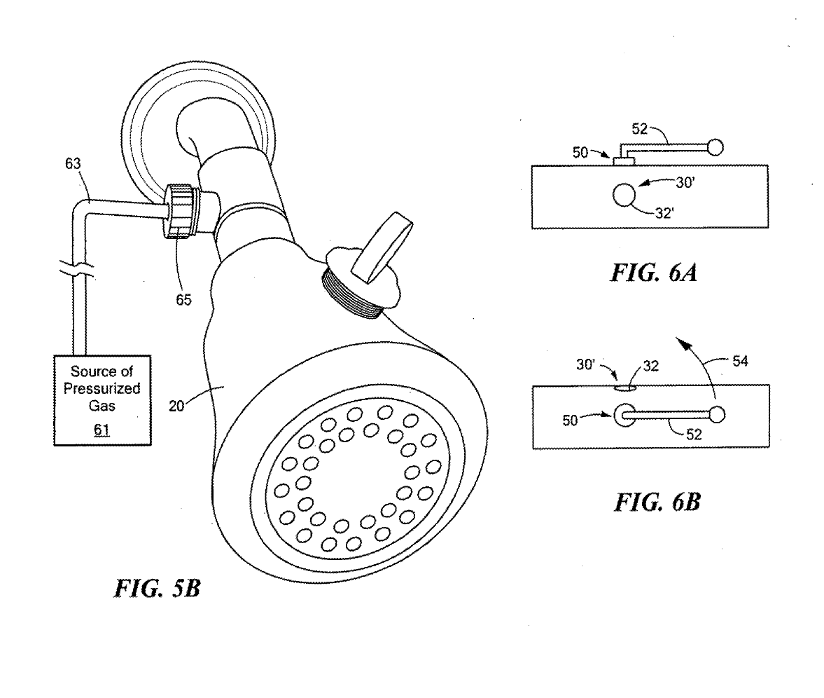

In one example, a dispensing device, e.g., dispenser 46, FIG. 5 with cap 47 and retractable nipple 49 may be used to inject the cleaning and disinfectant solution into port 30 to fill showerhead 20 with the solution. In other examples, the dispenser may be a syringe, funnel, or similar type device. Cap 36 is then screwed back onto port 30. The cleaning and disinfecting agent preferably remains inside showerhead 20 with cover 40 thereon for a predetermined amount of time, e.g., about 5 to 60 minutes, e.g., about 15 minutes. After a sufficient amount of time has been reached, as discussed above, cover 40 is removed. Hot water is preferably run for about 2 minutes to remove any remaining cleaning solution from showerhead 20.

In another example, source of pressurized gas 61, FIG. 5B, may be coupled to port 30 via line 63 and coupling 65. In this example, cover 40 need not be used and the pressurized gas from source 61 flows through line 63 and through showerhead 20 for about 5 to 60 minutes, e.g., about 15 minutes. This cleans and disinfects showerhead 20 by removing the buildup of calcium and/or lime and/or other heavy materials and/or biofilm inside showerhead 20 and killing most of the bacteria, mold, and the like, inside showerhead 20.

The result is the showerhead cleaning system 10 effectively cleans showerhead 20 by removing the buildup of calcium, and/or lime and/or other heavy materials and/or biofilm, and the like. This helps disinfect showerhead 20 because the majority of the medium for the growth of bacteria, mold, lime, and the like, inside showerhead 20 is reduced or removed. Showerhead cleaning system 10 also disinfects showerhead 20 by killing a majority of the bacteria, mold, lime, and the like, therein. Once system 10 is installed, showerhead 20 does not need to be removed again. This eliminates some of the problems associated with some conventional systems for cleaning a showerhead, such as loose plumbing connections which may result when a showerhead is repeatability removed, which can cause unsuspecting mold. Showerhead cleaning system 10 is also easy to install and operate and is relatively inexpensive when compared to the conventional showerhead cleaning systems delineated in the Background section above.

In one embodiment, injection device 12, FIG. 2A preferably includes opening 26, shown in greater detail in FIG. 2B, having external threads 28 thereon which may mate with internal threads (not shown) of coupling 18, FIG. 1, of showerhead 20. Port 30, FIG. 2A, preferably includes opening 32 and external threads 34 thereon. Cap 36, FIG. 1, may include internal threads 38, FIG. 3A, which mate with external threads 34, FIG. 2A of port 30. Cap 36 may be secured to port 30 by other means known to those skilled in the art. In other designs, port 30′, FIGS. 6A-6B, may be configured as ball valve assembly 50 with lever 52. In this design, lever 52 is positioned to the open position, as shown by arrow 54, to allow the cleaning agent, e.g., the cleaning and disinfecting solution or gas discussed above to be injected into opening 32′ of port 30′ in order to fill showerhead 20.

In one design, injection device 12, FIG. 2A, preferably includes opening 24 which increases the flow of water from showerhead extension pipe 14, FIG. 2B. Injection device 12 preferably includes internal threads 36 (also shown in FIG. 2B) which mate with external threads (not shown) on showerhead extension pipe 14. FIGS. 2C and 2D show in further detail one example of the structure injection device 12 and port 30. FIG. 3B shows in further detail one example the structure of cap 36. Exemplary dimensions of injection device 12 and cap 36 are shown in FIGS. 2A-2B and 3A-3B. Other dimensions may be utilized as needed.

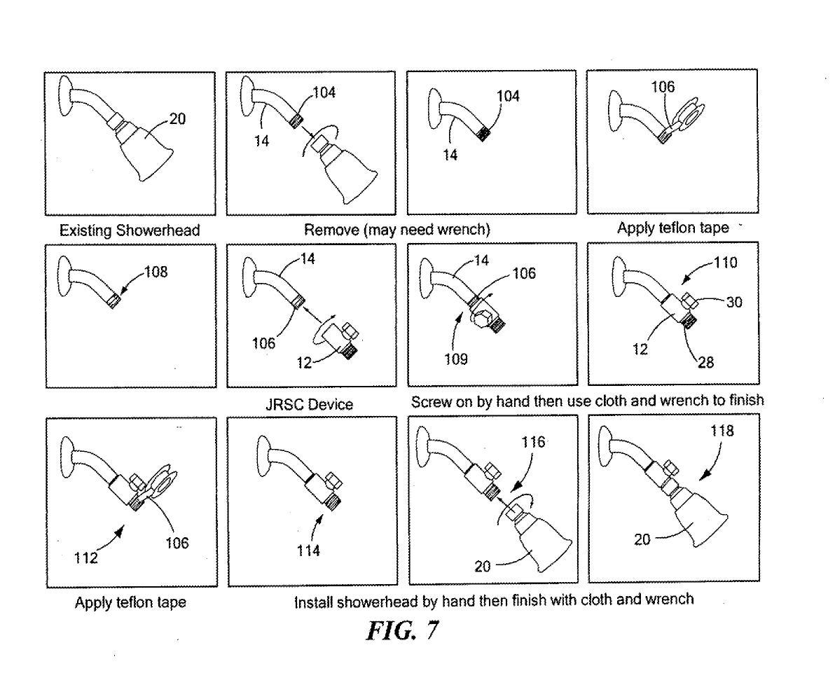

One exemplary operation of the steps of installing showerhead cleaning system 10 is now discussed with reference to FIG. 7. Existing showerhead 20 is removed by twisting the showerhead counter-clockwise by hand, or with a wrench if needed. This exposes threads 104 of existing extension pipe 14. Teflon® tape 106, or a similar type tape, is then applied over threads 104 as shown at 108. Port 30 is then threaded over threads 106 of shower extension pipe 14, as shown at 109. The completed process is shown at 110. Threads 28 of adapter 20 are exposed as shown. Teflon® tape 106, or similar type tape, is then applied over threads 28 as shown at 112 and 114. Existing showerhead 20 is then threaded over threads 28 and Teflon® tape 106, as shown at 116 and 118. System 10 is now ready to use.

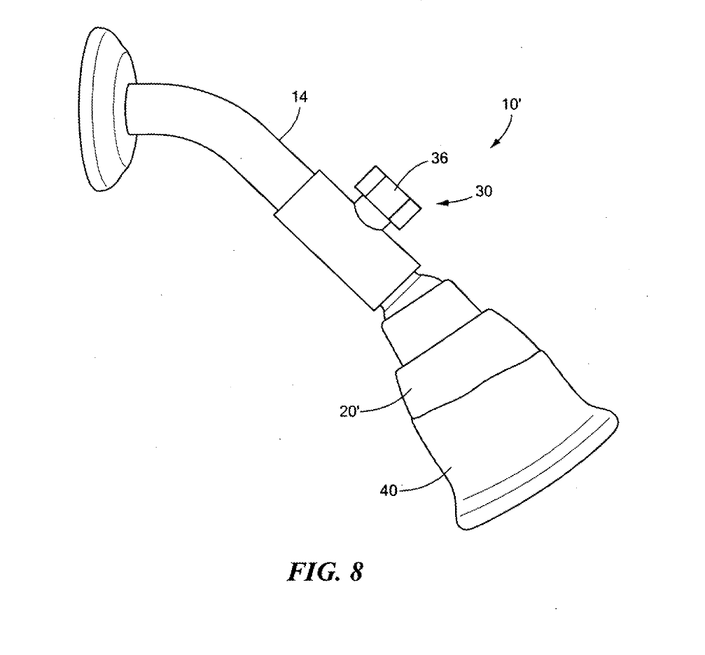

As discussed above with reference to FIGS. 1-7, shower cleaning system 10 may include injection device 12 with port 30 located between showerhead extension pipe 14 showerhead 20. In this example, port 30 is located on injection device 12. In another. embodiment, showerhead cleaning and disinfecting system 10′ FIG. 8, where like parts have been given like numbers, includes port 30 which is integrated with showerhead 20′. Similar as discussed above, port 30 may include cap 36 or be configured as a ball valve assembly 50, FIGS. 6A-6B, or similar type design. In this example, showerhead 20′, FIG. 8, connects directly to showerhead extension pipe 14, e.g., via threads or similar type design. System 10′ may also include an agent (solution or gas) for cleaning and disinfecting showerhead 20 and may include cover 40. System 10′ operates similar as discussed above with reference to FIGS. 1-6.

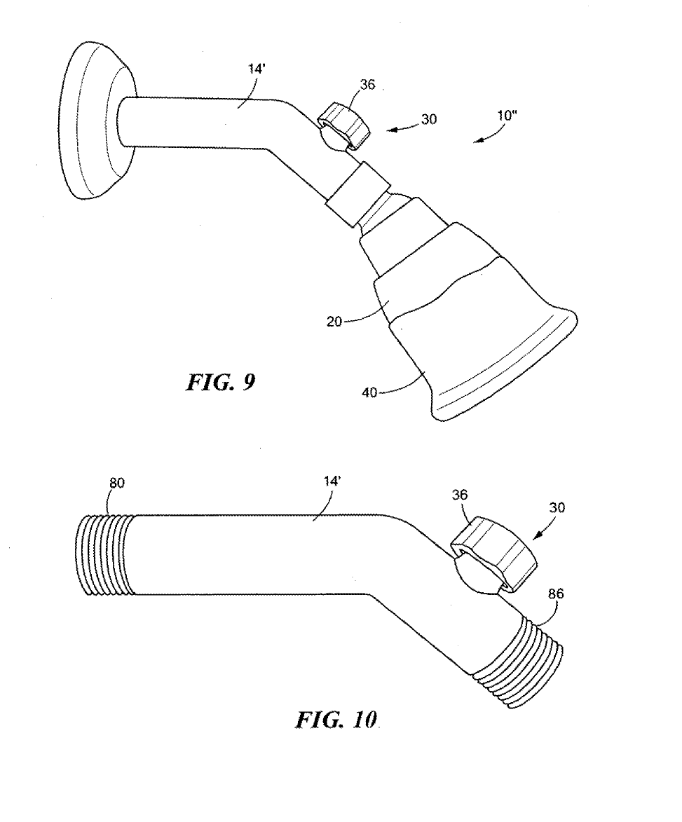

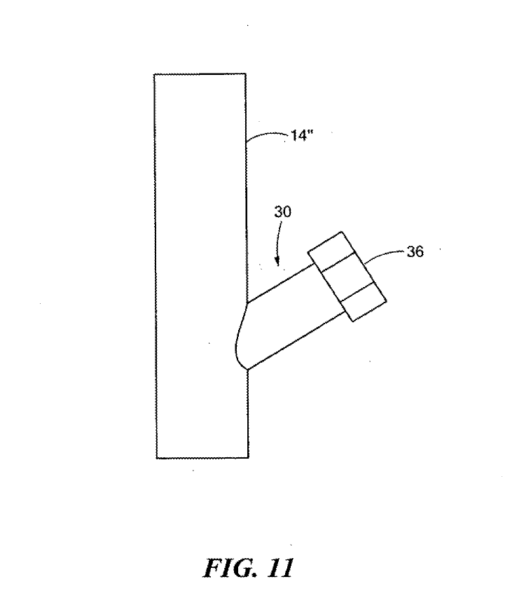

In other designs, showerhead cleaning and disinfecting system 10″, FIG. 9, where like parts have like numbers, includes port 30 which is preferably manufactured as part of showerhead extension pipe 14′. Similar as discussed above, port 30 may include cap 36 or may be configured as a ball valve assembly 50, FIGS. 6A-6B, or similar type design. Extension pipe 14′, FIG. 10, preferably includes external threads 80 which typically mate with the internal threads of a coupling behind the wall where extension pipe 14′ is installed. Extension pipe 14′ also preferably includes threads 86 which mate with the threads on showerhead 20, similar as discussed above. Port 30, FIGS. 9-10, preferably includes cap 36 having a similar design as discussed above with reference to FIGS. 1-3B. Port 30 may also be configured as ball valve assembly 50, FIG. 6. Showerhead extension pipe 14′, FIGS. 9-10, may also have the shape shown in FIG. 11. System 10″ may also include an agent (solution or gas) for cleaning and disinfecting showerhead 20 and may include cover 40. System 10′ operates similar as discussed above with reference to FIGS. 1-6.

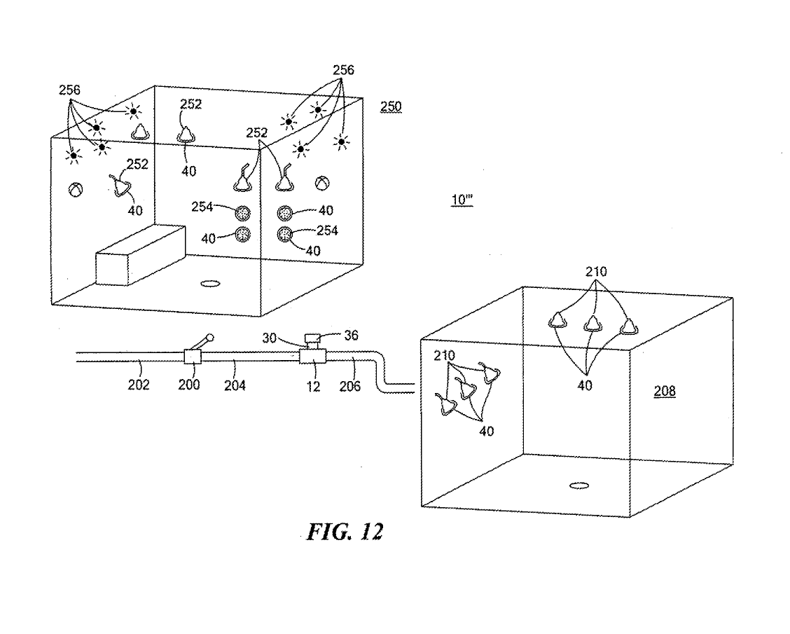

In another embodiment, showerhead cleaning and disinfecting system 10″, FIG. 12, where like parts have been given like numbers, may be utilized to clean and disinfect a multi-showerhead environment. In this example, valve 200 is preferably coupled to water supply line 202. Valve 200 has an open position which allows the water supply in water line 202 to flow therethrough to line 204 and a closed position which stops the flow of water from water supply line 202. System 10′″ also includes injection device 12 with port 30 having the same structure as discussed above with reference to FIGS. 1-6. However, in this design, injection device 12 is coupled to line 206 which connects to multi-shower environment 208 which includes at least a plurality of showerheads 210.

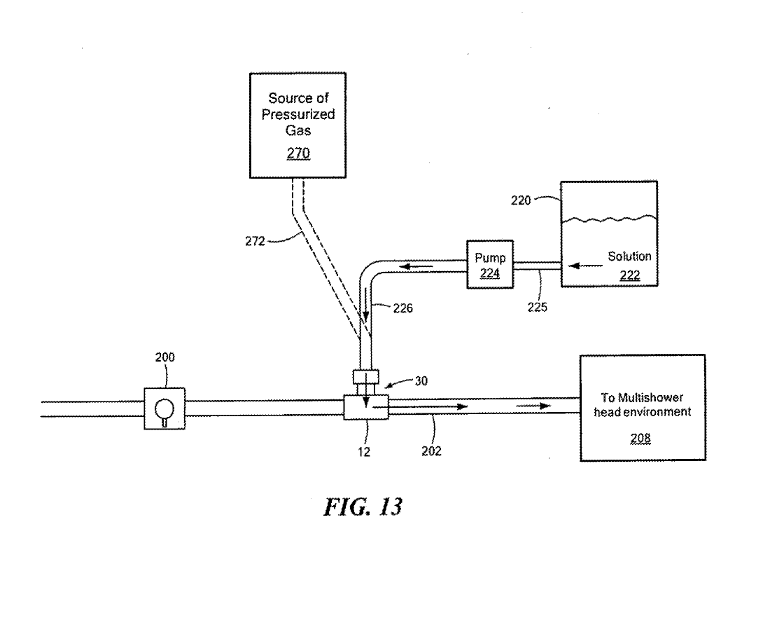

In one example, in order to clean the plurality of showerheads 210, valve 200 is closed to stop the flow of water from water supply line 202. Cleaning and disinfecting solution 220, FIG. 13, preferably stored in container 222, is then pumped to port 30 by lines 225 and 226 using pump 224. In one exemplary operation, cleaning and disinfecting solution 220 is pumped into each of the plurality of showerheads 210, FIG. 12, until the cleaning solution begins to flow out of each showerhead 210. Covers 40, FIG. 12, having a similar design as cover 40 discussed above with reference to FIGS. 4A-4C, are then secured to one or more or each of the plurality of showerheads 210, FIG. 12. Similar, as discussed above, the cleaning solution remains inside each of showerheads 210 for a predetermined amount of time necessary to clean and disinfect showerheads 210. After a sufficient period of time has been reached, covers 40 are removed. Valve 200 is opened and hot water is allowed to pass through showerheads 210 for about 2 minutes.

In one embodiment, multi-shower environment 208, FIG. 12, may also include atmosphere spa 250 which includes a plurality of showerheads 252 and/or back-spray showerheads 254, which may be similarly cleaned by attaching covers 40 and injecting the cleaning and disinfecting solution therein, as discussed above with reference to FIGS. 12 and 13.

In another example, system 10′″, FIG. 12, may utilize a pressurized gas, e.g., as discussed above with reference to FIG. 5B, as the cleaning and disinfecting agent. In this example, source of pressurized gas 270, FIG. 13, is coupled to port 30 via line 272. In this example, covers 40, FIG. 12, are not used. Instead, the gas from source of pressurized gas 270 flows through port 30 into line 206 and then to each of plurality of showerheads 210, FIG. 12, for a predetermined amount of time, e.g., about 5 to 60 minutes, e.g., about 15 minutes, to effectively clean and disinfect the plurality of showerheads 210. The same method may be used to clean and disinfect showerheads 252 and 254 of atmosphere spa 250.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

Other embodiments will occur to those skilled in the art and are within the following claims.

What is claimed is:

1. A showerhead cleaning and disinfecting system for a showerhead environment comprising:
a showerhead environment including one or more showerheads;
a shut off valve between a water supply line and the showerhead environment;
an injection device located between the shut off valve and the showerhead environment, the injection device including a port consisting of a screw cap or a value to release pressure on the plumbing pipes configured to receive an agent for cleaning and disinfecting the showerhead when the shutoff valve is closed;
A cap that prevents the cleaning agent from running out the showerhead

2. The system of claim 1 in which the injection device is located between the showerhead and the extension pipe;

3. The system of claim 1 in which the injection device is built into the showerhead with a valve or screw cap

4. The system of claim 1 in which the injection device is built into the extension pipe

5. The system of claim 1 in which the injection device is capable of receiving a gas into the environment for the purpose of cleaning and disinfecting the environment

6. The system of claim 1 in which the injection device is attached to a pumping device to provide a cleaning solution into the environment for a predetermined amount of time.
